(19) United States
(12) Patent Application Publication
(10) Pub. No.: US 2007/0024588 A1
(43) Pub. Date: Feb. 1, 2007

(54) Keyboard lighting device

(76) Inventors: Memphis Zhihong Yin, Tomball, TX (US); Mark S. Tracy, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/190,256

(22) Filed: Jul. 26, 2005

(51) Int. Cl. G09G 5/00

(52) U.S. Cl. 345/168

(57) ABSTRACT

A keyboard lighting device is disclosed. In a preferred embodiment, a moving member may be placed in an operating position protruding from the keyboard, or in a retracted position. In the operating position, light is redirected from a light source to the keyboard so that use of the keyboard in dark environments is facilitated. Preferably, when the moving member is in its retracted position, the keyboard light appears to be a key on the keyboard.

### FIELD OF THE INVENTION

present invention relates to portable electronic devices, and more specifically to supplemental keyboard lighting for a portable electronic device.

### BACKGROUND

A laptop or “notebook” portable computer serves as an example of a portable electronic device. FIG. 1 shows a simplified perspective view of a typical laptop portable computer 100. Computer 100 comprises a base portion 101, further comprising a keyboard 103 and other input devices, and a display portion 102, comprising a display for communicating information to a user of computer 100. Keyboard 103 further comprises a row 104 of special function keys, in addition to the alphabetic and numeric keys typically found on a keyboard.

A portable device such as computer 100 is intended to be used in many different environments. For example, computer 100 may be used out of doors, in a car, on an airplane, or in nearly anywhere else the user desires. Computer 100 may operate for a limited time on battery power when no external supply of power is available. Not all of these usage locations are ideal working environments. For example, during a long airline flight, cabin lighting is often extinguished so that the passengers can sleep. A passenger wishing to continue working at his seat after “lights out” may have difficulty seeing keyboard 103.

Various devices have been proposed for illuminating a portable device keyboard. Many require additional equipment to be carried with the portable device. Kim (U.S. Pat. No. 6,336,727) describes a lighting device integrated into a cursor control device that resides near the center of a computer keyboard. However, not all computers or other portable devices use the kind of cursor control device described by Kim, and such a device may not extend high enough above the keyboard to provide sufficient light.

### BRIEF DESCRIPTION OF THE DRAWINGS

FIG. 1 shows a simplified perspective view of a laptop portable computer.

FIG. 2 shows a simplified perspective view of a laptop portable computer in accordance with an example embodiment of the invention.

FIG. 3 shows a cutaway perspective view of a keyboard light, in accordance with an example embodiment of the invention, in its operating position.

FIG. 4 shows the example computer of FIG. 2 with a keyboard light, in accordance with an example embodiment of the invention, in a retracted position.

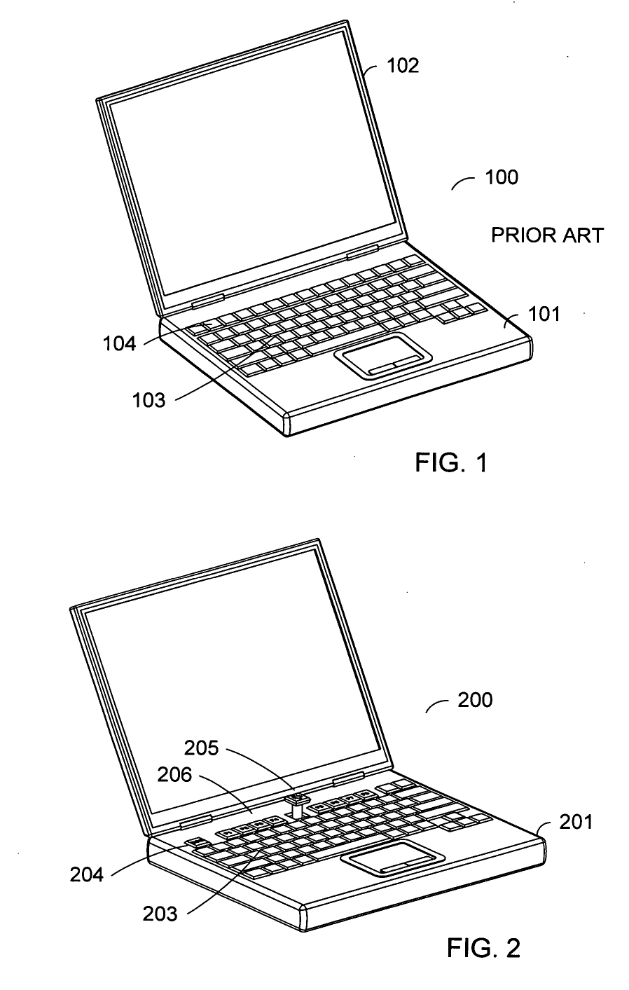

### DETAILED DESCRIPTION

FIG. 2 shows a simplified perspective view of a laptop portable computer 200 in accordance with an example embodiment of the invention. Example computer 200 comprises a base portion 201, further comprising a keyboard 203. Keyboard 203 further comprises a row 204 of special function keys. Because there are more available key positions than are needed to provide special functions, one of the key positions is usurped by a keyboard light 205 in accordance with an example embodiment of the invention. While a key position is a convenient place for keyboard light 205, keyboard light 205 might also be placed in any otherwise-blank part of base portion 201, such as area 206. Keyboard light 205 is preferably placed approximately midway along the rows of keys of keyboard 203, in or near the “top” row of keys (the row furthest from the user, row 204 in the example embodiment), and such that it does not interfere when the computer user types on keyboard 203. In FIG. 2, keyboard light 205 is shown in its operating position.

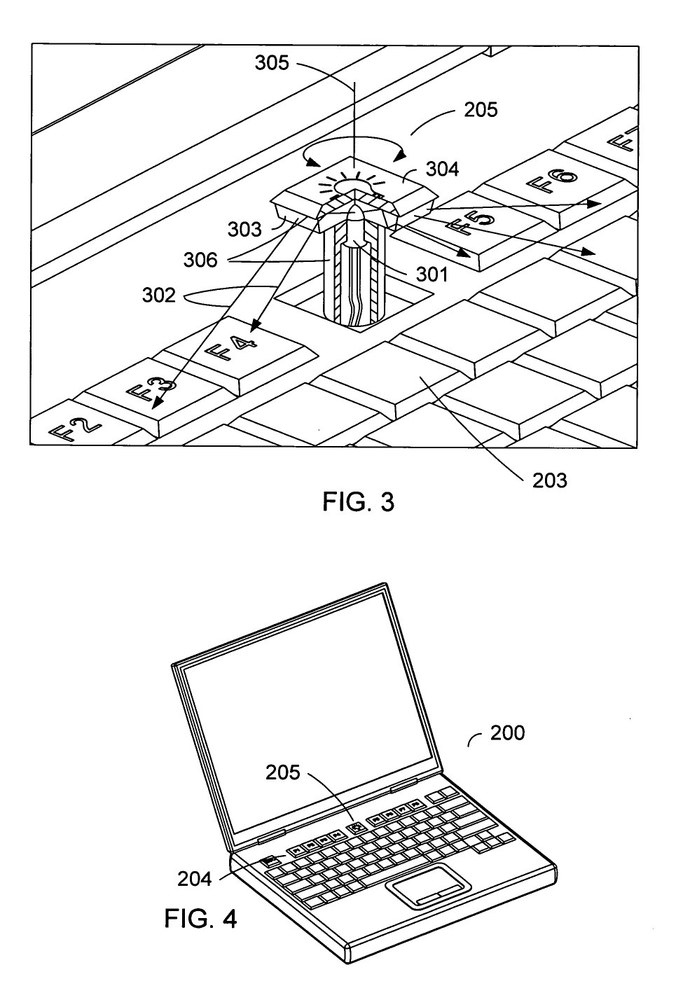

FIG. 3 shows a cutaway perspective view of example keyboard light 205 in its operating position. Keyboard light 205 comprises a moving member 306, which includes the moving parts of keyboard light 205. Keyboard light 205 further comprises a light source, such as light emitting diode (LED) 301. While the example embodiment of FIG. 3 uses an LED as its light source, another kind of light source may be used, such as an incandescent lamp or another kind of light source. The light source is powered by any of a number of means well known in the art. LED 301 emits light, represented by light rays 302. The light transmits through light pipe 303, which is shaped to disperse the light effectively over keyboard 203. Light pipe 303 may be made of a clear plastic material such as polycarbonate or acrylic. In an alternative embodiment, a light source such as LED 301 is mounted to a feature such as a circuit board inside computer 200 and does not move with the key-shaped portion of keyboard light 205. Keyboard light 205 may comprise a second light pipe that transfers light from the fixed light source to light pipe 303, or a single light pipe may transfer light from the fixed light source to keyboard 203. One of skill in the art will recognize that light-transfer mechanisms other than a light pipe may be used. For example, keyboard light 205 may redirect light from a light source such as LED 301 using mirrors, lenses, diffuse reflective surfaces, prisms, light pipes, or other optical components, or any of these in combination.

A designer of skill in the art may choose the number, orientations and surface treatments of the various surfaces of keyboard light 205 so as to work effectively to achieve a design goal using the light source chosen in a particular embodiment. For example, the designer may strive to distribute the light from the chosen light source as evenly as possible over keyboard 203, or may strive to deliver the largest possible portion of the light from the light source to keyboard 203. Other design goals may be envisioned.

Preferably, keyboard light 205 is rotatable about its vertical axis 305, so that light may be directed preferentially to particular parts of keyboard 203.

During times when supplemental illumination is not needed or desired, moving member 306 may be retracted into base portion 201. FIG. 4 shows example computer 200 with example moving member 306 in a retracted position. In the example embodiment of FIG. 4, when moving member 306 is retracted, keyboard light 205 harmonizes visually with the keys in row 204 of special function keys. That is, it appears to be a key on keyboard 203.

The retraction of keyboard light 205 and its extension to its operating position are preferably performed using a “push-push” mechanism. A push-push mechanism allows alternately latching of a surface in a retracted and an extended position. Each transition between the retracted position and the extended position is accomplished by pushing on the mechanism. That is, the push-push mechanism alternately places moving member 306 in its operating position and its retracted position. In example computer 200, the user presses on the upper surface 304 (shown in FIG. 3) of keyboard light 205 to retract moving member 306 from its operating position, and also presses on upper surface 304 to raise moving member 306 to its operating position from its retracted position.

In a preferred embodiment, keyboard light 205 comprises an illuminated pushbutton switch, which further comprises a push-push mechanism, so that LED 301 is illuminated automatically when moving member 306 is in its operating position and is shut off automatically when moving member 306 is in its retracted position. Alternatively, control of LED 301 is independent of the position of moving member 306. For example, LED 301 may be controlled by a separate switch actuated by the user of computer 200, or may be controlled through software installed in computer 200.

Push-push mechanisms and illuminated pushbutton switches are well-known in the mechanical arts and need not be described in detail here. See, for example, U.S. Pat. No. 3,651,700 to Bailey, which describes an example push-push mechanism. U.S. Pat. No. 3,969,609 to Wanner et al. describes an example illuminated push button switch that may be illuminated in response to its selected position, or may be illuminated by a control independent of the switch position. Illuminated pushbutton switches are available from a variety of manufacturers, including NKK Switches of Scottsdale, Ariz., USA and ITT Industries, Cannon of Newton, Mass., USA.

While a laptop portable computer has thus far been used as an example portable electronic device in which the invention may be embodied, the invention may be embodied in other portable electronic devices as well, for example a personal digital assistant (PDA). A PDA is typically a handheld device that comprises a display screen and a keyboard. Software and hardware comprised in a PDA may enable the device to act as a wireless telephone, an internet access device, or to perform computer-like functions for the convenience of the user. For example, a PDA may allow the user to access electronic mail, store and play digital sound files, store and display digital photographs, to do word processing, or other functions.

1. A keyboard light for a portable electronic device, comprising:
a light source; and
a mechanism that alternately positions a moving member in an operating position and a retracted position;
and wherein when the moving member is in the operating position, the moving member protrudes from the keyboard and light is redirected from the light source onto the keyboard.

2. The keyboard light of claim 1, wherein the light source is a light emitting diode.

3. The keyboard light of claim 1, wherein the light source moves with the moving member.

4. The keyboard light of claim 1, wherein the keyboard light occupies an otherwise-blank area on a face of the electronic device proximate the keyboard.

5. The keyboard light of claim 1, wherein the keyboard light occupies a key position of the keyboard.

6. The keyboard light of claim 1, wherein when the moving member is in the retracted position, the keyboard light appears to be a key on the keyboard.

7. The keyboard light of claim 1, further comprising a light pipe that redirects the light onto the keyboard.

8. The keyboard light of claim 1, wherein the moving member is rotatable about its vertical axis.

9. The keyboard light of claim 1, wherein:
the light source is turned on automatically when the moving member is placed in the operating position; and
the light source is turned off automatically when the moving member is placed in the retracted position.

10. The keyboard light of claim 1, wherein the light source is switched independently of the position of the moving member.

11. The keyboard light of claim 1, wherein the mechanism is a push-push mechanism.

12. A portable electronic device, comprising a keyboard and a keyboard light, the keyboard light further comprising:
a light source; and
a mechanism that alternately places a moving member in an operating position and a retracted position;
and wherein when the moving member is in its operating position, the moving member protrudes from the keyboard and light is directed from the light source to the keyboard.

13. The portable electronic device of claim 12, wherein the keyboard light occupies a key position on the keyboard.

14. The portable electronic device of claim 12, wherein the keyboard light is positioned near a center of a top row of the keyboard.

15. The portable electronic device of claim 12, wherein the portable electronic device is a laptop portable computer.

16. The portable electronic device of claim 12, wherein the portable electronic device is a personal digital assistant.

17. The portable electronic device of claim 12, wherein when the moving member is in its retracted position, the keyboard light appears to be a key on the keyboard.

18. The portable electronic device of claim 12, further comprising at least one light-transfer mechanism that redirects the light from the light source to the keyboard.

19. The portable electronic device of claim 18, wherein each light-transfer mechanism is selected from a set of light transfer mechanisms consisting of light pipes, prisms, mirrors, diffuse reflecting surfaces, and lenses.

20. A method, comprising:
pushing on an upper surface of a moving member of a light for a keyboard, thereby raising the moving member to an operating position from which light is directed to the keyboard; and
subsequently pushing on the upper surface, thereby placing the moving member in a retracted position.

21. A keyboard light, comprising:
light source means;
means for alternately placing a moving member in a raised operating position and a retracted position;
means for directing light from the light source means to the keyboard.
